(19) United States
(12) Patent Application Publication
(10) Pub. No.: US 2010/0154902 A1
(43) Pub. Date: Jun. 24, 2010

(54) Hydraulic Shut-Off Valve with Surge Resistant Chamber

(76) Inventor: Donald Loper, Milwaukee, WI (US)

Correspondence Address: GODFREY & KAHN S.C., 780 NORTH WATER STREET, MILWAUKEE, WI, 53202, US

(21) Appl. No.: 12/644,579

(22) Filed: Dec. 22, 2009

Related U.S. Application Data
(63) Continuation-in-part of application No. 11/836,302, filed on Aug. 9, 2007, now abandoned.
(60) Provisional application No. 60/837,600, filed on Aug. 9, 2006.

(51) Int. Cl. F16K 15/02; F15B 20/00

(52) U.S. Cl. 137/517

(57) ABSTRACT

A shut-off valve capable of operating appropriately within a hydraulic line to respond to both catastrophic line break events and fluctuations without unnecessarily interfering with the operation of the hydraulic systems.

### CROSS-REFERENCE TO RELATED APPLICATIONS

This application is a continuation-in-part of U.S. Nonprovisional patent application Ser. No. 11/836,302, filed Aug. 9, 2007, which claims priority to U.S. Provisional Patent Application No. 60/837,600, filed Aug. 9, 2006, and of U.S. Nonprovisional patent application Ser. No. 11/933,266, filed Oct. 31, 2007.

### FIELD OF INVENTION

The present invention relates to the field of hydraulic shut-off valves, and more specifically to a shut-off valve which has the capability to distinguish between fluctuations and line breaks.

### BRIEF DESCRIPTION OF THE DRAWINGS

FIG. 1 illustrates a sectional view of an exemplary embodiment of a shut-off valve with an integrally constructed surge resistant volumetric pressure vessel.

FIG. 2 illustrates an exploded view of an exemplary embodiment of volumetric pressure vessel valve.

FIGS. 3a through 3c illustrate cross-sectional views of various embodiments of a shut-off valve with an integrally constructed surge resistant volumetric pressure vessel with various designs of the volumetric pressure vessel component.

FIG. 4 illustrates an exemplary hydraulic system using volumetric pressure vessel valves at various locations within a hydraulic system.

### GLOSSARY

As used herein, the term “fluctuation” refers to a continual change from one point or condition to another.

As used herein, the term “line break” refers to a disruption in a line, e.g., a hydraulic line, which causes a reduction in pressure.

As used herein, the term “Reynolds number representation” refers to a dimensionless number that gives a measure of the ratio of inertial forces to viscous forces and consequently quantifies the relative importance of these two types of forces for given flow conditions.

As used herein, the term “volumetric pressure vessel” component refers to a component of a volumetric pressure vessel valve through which fluid passes and/or accumulates.

As used herein, the term “volumetric pressure vessel” refers a fluid retaining cavity or other fluid retaining structure which is designed to accumulate fluid and create a counter pressure to resist movement of a spool and create a time delay in the functioning of a shut-off valve or velocity fuse, reducing equipment disruption due to system surges.

### BACKGROUND

Injuries resulting from hydraulic line breaks happen almost daily. Various shut-off valves are known the art and are commonly referred to as “velocity fuses.”

Velocity fuses are currently required when human “loads” are being lifted (e.g., on a utility or service truck), and are very effective for stopping a load from free falling if there is a sudden loss of pressure on a hydraulic line which may signal a line break. The velocity fuse will lock a hydraulic cylinder in place by preventing a fluid from leaving the cylinder when pressure is lost.

A typical velocity fuse known in the art works by sensing the flow across a control orifice. When the pressure differential exceeds a particular “trip set” or “shut off point, a spring biased poppet will close, causing the fuse to shut off the flow to the outlet. Examples of velocity fuses known in the art are found in U.S. Pat. No. 4,383,549 (Adjustable Velocity Fuse for Hydraulic Line) and U.S. Pat. No. 6,443,180 (Hydraulic Line Adjustable Velocity Fuse with Dampling). Both of these patent applications discuss the use of “chambers” as communicating ports.

There are several problems with velocity fuses known in the art. In particular, velocity fuses cause equipment disruption. Because of this limitation, velocity fuses can be used only in actuators and not throughout an operating system.

One problem known in the art is that velocity fuses are triggered solely by fluctuations in line pressure, and cannot distinguish between events where a line has been broken and situations where there are simply fluctuations in velocity due to normal use and diversion of fluids.

Due to this inability to distinguish between a fluctuation and a line break, velocity fuses cause constant system interruptions. A velocity fuse will cause a hydraulic line to shut down and stop the flow of fluid each time a designated pressure differential is reached.

Because of their propensity to cause constant interruption, velocity fuses are used only on a very limited basis in lines where mandated by OSHA to protect human loads. Velocity fuses, despite their effectiveness, cannot be used in non-human load bearing lines of hydraulic systems (which are the majority of lines in the system).

Because velocity fuses known in the art cannot be used in non-human load bearing lines, the majority of lines in a system cannot be automatically shut off in the event of a line break, thus causing spillage, environmental pollution, injury, waste, and equipment damage.

It is desirable to have a shut-off valve that can distinguish between catastrophic line breaks and fluctuations in the flow of fluid through a working line.

### SUMMARY OF THE INVENTION

The present invention is an improved shut-off valve (velocity fuse) which includes a novel volumetric pressure vessel component which is a fluid retaining structure that causes a valve to resist shut off in the event of a fluid surge without restricting the volume of fluid that otherwise flows through the shut-off valve.

The volumetric pressure vessel component may vary in size, shape and capacity to modify its capability to withstand surges and avoid unnecessary equipment disruptions.

### DETAILED DESCRIPTION OF INVENTION

For the purpose of promoting an understanding of the present invention, references are made in the text to exemplary embodiments of a hydraulic shut-off valve with a surge resistant chamber, only some of which are described herein. It should be understood that no limitations on the scope of the invention are intended by describing these exemplary embodiments. One of ordinary skill in the art will readily appreciate that alternate but functionally equivalent hydraulic shut-off valve with a surge resistant volumetric pressure vessel may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change in the basic function to which it is related.

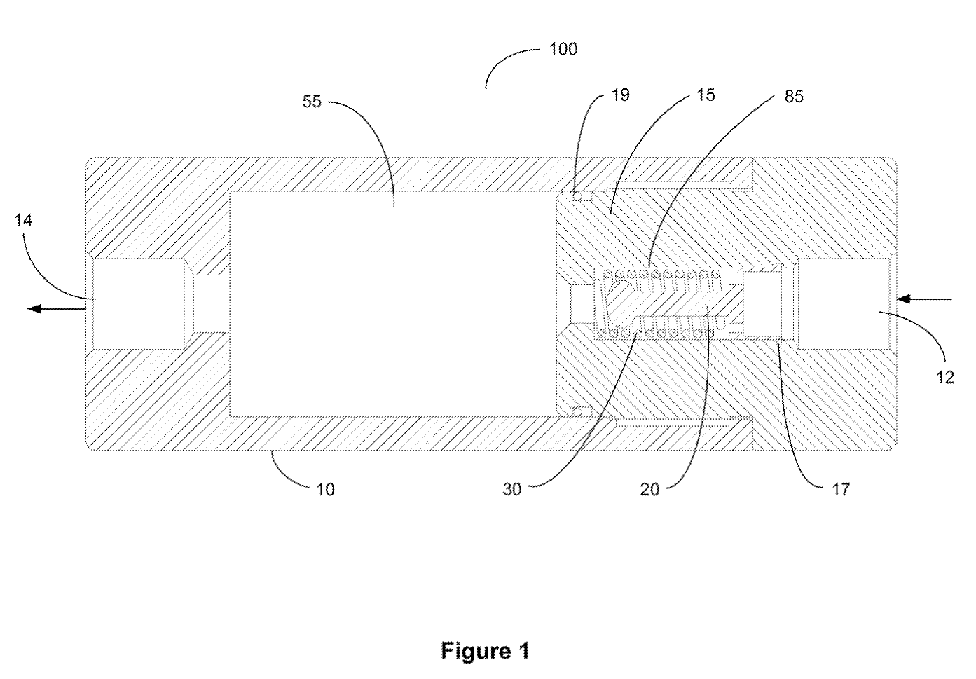

FIG. 1 is an exemplary embodiment of a shut-off valve with an integrally constructed surge resistant volumetric pressure vessel referred to as volumetric pressure vessel valve 100. In the embodiment shown, volumetric pressure vessel valve 100 includes valve housing 10. Valve housing 10 includes volumetric pressure vessel component 55 and velocity fuse assembly 85 known in the art. Valve housing 10 and volumetric pressure vessel component 55 can be of any shape or configuration known in the art (e.g., square, tubular, round, spiral, ribbed, multi-channeled, sieved, angular or any other shape or configuration).

Other embodiments of volumetric pressure vessel valve 100 may include multiple volumetric pressure vessel components 55, and volumetric pressure vessel valve 100 may be connected in series and parallel configurations in various systems.

Valve housing 10 includes inflow aperture 12 and outflow aperture 14. In the embodiment shown, the thickness of valve housing 10 is proportional to the volumetric pressure of the type of devices and hydraulic system in which volumetric pressure vessel valve 100 is used.

The volume and related psi, the type of material from which the valve is constructed, the type of fluid, and environmental conditions in which the valve is used are represented by the following formulas.

The Reynolds number representation is a formula which represents the relationship of the volume and viscosity of the fluid (not shown) passing through the diameters of inflow aperture 12 and outflow aperture 14 as follows:

$$\begin{matrix}{R}_{e} = \frac{V [ in \text{/} s ] \times D [ in ]}{v [ Cst ]} \\ = \frac{v \times D [ {in}^{2} \text{/} s ]}{v [ {mm}^{2} \text{/} s ]} \\ = \frac{{25.4}^{2} \times v \times D}{v} \to {R}_{e} \\ = \frac{{25.4}^{2} \times v [ in \text{/} s ] \times D [ in ]}{v [ Cst ]} \to \frac{{25.4}^{2} \times D [ in ]}{v [ Cst ]} \times \\ \frac{231 \times Q [ gpm ]}{60 \times A [ {in}^{2} ]} \to {R}_{e} \\ = \frac{4 \times {25.4}^{2} \times 231}{π \times 60} \times \frac{Q [ gpm ]}{v [ Cst ] \times D [ in ]} \to {R}_{e} \\ = \frac{3164.2 \times Q [ gpm ]}{v [ Cst ] \times D [ in ]} .\end{matrix}$$

### Coefficient of:

$$Laminar flow \to λ = \frac{64}{{R}_{e}} , \\ Turbulent flow \to λ = \frac{0.316}{{R}_{e}^{1 / 4}} ( Smooth conduit )$$

### Compressibility:

$$\begin{matrix}P = \frac{B [ psi ]}{SV [ {in}^{3} ]} \int ( {Q}_{in} - {Q}_{out} ) [ gpm ] d t [ s ] \\ = \frac{B [ psi ]}{SV [ {in}^{3} ]} \int ( {Q}_{in} - {Q}_{out} ) [ \frac{231 {in}^{3}}{60 s} ] d t [ s ] \to P [ psi ] \\ = \frac{231 \times B [ psi ]}{60 ⋆ SV [ {in}^{3} ]} \int ( {Q}_{in} - {Q}_{out} ) [ gpm ] d t [ s ]\end{matrix}$$

### Pressure Drop Across Sharp-Edge Orifice:

$$\begin{matrix}Q = {C}_{d} A \sqrt{\frac{2 Δ P}{SG \times {ρ}_{w}}} \\ = {C}_{d} A [ {in}^{2} ] \sqrt{\frac{2 Δ P [ {lb}_{f} \text{/} {in}^{2} ]}{SG \times 64.4 [ {lb}_{m} \text{/} {ft}^{3} ]}} \\ = {C}_{d} A [ {in}^{2} ] \sqrt{\frac{2 Δ P [ {lb}_{f} \times {ft}^{3} ]}{SG \times 64.4 [ {lb}_{m} \times {in}^{2} ]}} \\ = {C}_{d} A [ {in}^{2} ] \sqrt{\frac{2 Δ P [ 32.2 \times {lb}_{m} \times {ft}^{4} ]}{SG \times 64.4 [ {s}^{2} \times {lb}_{m} \times {in}^{2} ]}} \\ = {C}_{d} A [ {in}^{2} ] \sqrt{\frac{Δ P [ {ft}^{4} ]}{SG \times [ {s}^{2} \times {in}^{2} ]}} \\ = {C}_{d} A [ {in}^{2} ] \sqrt{\frac{Δ P [ {12}^{4} \times {in}^{2} ]}{SG [ {s}^{2} ]}} \\ = {C}_{d} A [ \frac{{in}^{3}}{s} ] \sqrt{\frac{Δ P}{SG}} \\ = \frac{0.611 \times {12}^{2} \times 60}{231} A [ {in}^{2} ] \sqrt{\frac{Δ P [ psi ]}{SG}} [ gpm ] \to Q [ gpm ] \\ = 22.85 \times 4 [ {in}^{2} ] \sqrt{\frac{Δ P [ psi ]}{SG}} \to Δ P [ psi ] \\ = \frac{SG \times {{Q}^{2} [ gpm ]}^{2}}{{22.85}^{2} \times {{A}^{2} [ {in}^{2} ]}^{2}}\end{matrix}$$

### Pressure Drop Across Long Conduit:

$$\begin{matrix}\begin{matrix}Δ p = λ \frac{L}{D} \frac{{v}^{2}}{2 g} ρ g \\ = λ \frac{L [ in ]}{D [ in ]} \frac{ρ [ \frac{{lb}_{m}}{{ft}^{3}} ] {v}^{2} [ \frac{{in}^{2}}{{s}^{2}} ]}{2} \\ = λ \frac{L}{D} \frac{ρ {v}^{2} [ {lb}_{m} \times {in}^{2} ]}{2 [ {ft}^{3} \times {s}^{2} ]} \\ = λ \frac{L}{D} \frac{ρ {v}^{2} [ {lb}_{m} \times {in}^{2} ]}{2 [ {ft}^{3} \times {12}^{3} \frac{{in}^{3}}{{ft}^{3}} {s}^{2} ]} \\ = λ \frac{L}{D} \frac{ρ {v}^{2} [ {lb}_{m} ]}{2 \times {12}^{3} [ in \times {s}^{2} ]} \\ = λ \frac{L}{D} \frac{ρ {v}^{2} [ {lb}_{m} \times ft ]}{2 \times {12}^{3} [ in \times {s}^{2} \times ft ]} \\ = λ \frac{L}{D} \frac{ρ {v}^{2} [ Poundal ]}{2 \times {12}^{3} [ in \times ft ]} \\ = λ \frac{L}{D} \frac{ρ {v}^{2} [ Poundal ]}{2 \times {12}^{4} [ {in}^{2} ]} \\ = λ \frac{L}{D} \frac{ρ {v}^{2} [ {lb}_{f} ]}{2 \times {12}^{4} \times 32.2 [ {in}^{2} ]} \\ = λ \frac{L}{D} \frac{SG \times {ρ}_{w} \times {v}^{2} [ {lb}_{f} ]}{2 \times {12}^{4} \times 32.2 [ {in}^{2} ]} \\ = λ \frac{L}{D} \frac{SG \times 64.4 \times {v}^{2} [ {lb}_{f} ]}{2 \times {12}^{4} \times 32.2 [ {in}^{2} ]} \to Δ p [ psi ] \\ = λ \frac{L [ in ] \times SG \times {{v}^{2} [ in \text{/} s ]}^{2}}{{12}^{4} \times D [ in ]}\end{matrix} & \\ \begin{matrix}v = Q [ gpm ] \text{/} A [ {in}^{2} ] \\ = \frac{Q [ {in}^{3} \times 231 ]}{A [ 60 \times s \times {in}^{2} ]} \to v [ \frac{in}{s} ] \\ = \frac{231 \times Q [ gpm ]}{60 \times A [ {in}^{2} ]}\end{matrix} \\ \begin{matrix}\to Δ p [ psi ] = \frac{λ \times L \times SG \times {231}^{2} \times {Q}^{2}}{{12}^{4} \times D \times {60}^{2} \times {A}^{2}} \\ = \frac{7.1482 \times {10}^{- 4} \times λ \times L \times SG \times {Q}^{2}}{D \times {A}^{2}}\end{matrix} \\ \begin{matrix}\to Δ p [ psi ] = \frac{λ \times L \times SG \times {Q}^{2}}{{37.4}^{2} \times D \times {A}^{2}} \to Q [ gpm ] \\ = 37.4 \times A [ in ] \sqrt{\frac{D [ in ] \times Δ p [ psi ]}{λ \times L [ in ] \times SG}}\end{matrix} & \end{matrix}$$

### Value Formula in Circuit:

$${P}_{CO} = {P}_{CR} [ 1 + ( OV / 100 ) ]$$

$$if {P}_{1} \leq {P}_{CR} \to {Q}_{RV} = 0$$

$$if {P}_{CR} < {P}_{1} < {P}_{CO} \to {Q}_{RV} = Qp \times [ \frac{{P}_{1} - {P}_{CR}}{{P}_{CO} - {P}_{CR}} ]$$

$$if {P}_{1} \geq {P}_{CO} \to {Q}_{RV} = {Q}_{p}$$

$${Q}_{SV} = {Q}_{p} - {Q}_{RV}$$

### Formula Index

| | |
|---|---|
| ΔP | General pressure difference |
| ΔP_{DV} | Pressure drop across the directional valve |
| ρ_{f}/ρ_{w} | Fluid density/water density |
| A | General area |
| A₁ | Projected area at the upstream side of the spool |
| A₁₂ | Fixed restricted area between upstream side of the spool and |
| | the spring chamber |
| A₂ | Projected area at the downstream side of the spool |
| A₂₃ | Variable restricted area at the entrance of the surge chamber |
| A₃ | Spool face projected area when the spool advancing in the |
| | inlet of the surge chamber |
| A₃₄ | Fixed restricted area at the outlet of the surge chamber |
| Aₜₕ | Throttling area of the tank line throttle |
| B | Fluid bulk Modulus |
| C_{d} | Discharge coefficient |
| D_{SL1} | Sleeve geometrical diameter |
| D_{SL2} | Sleeve geometrical diameter |
| D_{SL3} | Sleeve geometrical diameter |
| D_{SP1} | Spool geometrical diameter |
| D_{SP2} | Spool geometrical diameter |
| D_{SP3} | Spool geometrical diameter |
| D_{SP4} | Spool geometrical diameter |
| D_{SP5} | Spool geometrical diameter |
| Dₜₕ | Throttling diameter of the tank line throttle |
| k_{f} | Viscous friction coefficient |
| kₓ | Spring stiffness |
| L_{SL1} | Sleeve geometrical length |
| L_{SL2} | Sleeve geometrical length |
| L_{SL3} | Sleeve geometrical length |
| L_{SL4} | Sleeve geometrical length |
| L_{SP1} | Spool geometrical length |
| L_{SP2} | Spool geometrical length |
| L_{SP3} | Spool geometrical length |
| L_{SP4} | Spool geometrical length |
| Mₛₚ | Spool mass |
| OV | Relief valve % pressure override |
| P₁(Pₚᵤₘₚ) | Pump pressure |
| P₂ | Safety valve spring chamber pressure |
| P₃ | Safety valve surge chamber pressure |
| P₄(P_{load}) | Load pressure including pressure drop across the directional |
| | valve and return line pressure |
| P₅(Pₚᵤₘₚ) | Back pressure before tank line throttle |
| P_{CO} | Relief valve dead head pressure |
| P_{CR} | Relief valve cracking pressure |
| P_{EL} | Pressure equivalent to the external load |
| Q | General flow rate |
| Q₃₄ | Flow from surge chamber to the system |
| Qₚ | Flow source (from the pump) |
| Q_{RV} | Flow through the relief valve |
| Q_{SV} | Flow into surge chamber from the spring chamber |
| Qₜₕ | Flow through tank line throttle valve |
| S(Sₘₐₓ) | Instantaneous (maximum) spool displacement |
| S′ | Spool velocity |
| S″ | Spool acceleration |
| SG | Fluid specific gravity |
| Vₛ | Volume of the surge chamber |
| Xᵣₘₐₓ | Spring maximum (Free) length |

Inflow aperture 12 and outflow aperture 14 may be of various shapes, configurations, and diameters.

In the embodiment shown, volumetric pressure vessel valve 100 is constructed from steel, but in other embodiments may be constructed from aluminum, steel, carbon fiber, fiber glass, plastic, alloys and composites, copper, brass, and/or synthetic materials. In various embodiments, volumetric pressure vessel valve 100 may be used in medical and veterinary applications and may be composed of biological and biologically compatible materials (e.g., in the event that this valve is used in human or animal subjects).

Valve housing 10 may be constructed of one unitary component or of multiple integrated, adjustable and modular components integrated to form valve housing.

Also shown in FIG. 1 are spring 30, snap ring 17 and spool 20. In the embodiment shown, valve housing 10 allows a predetermined level of fluid, measured in cubic inches, to pass through and to accumulate in volumetric pressure vessel component 55.

FIG. 1 further illustrates spool housing 15. In the embodiment shown, volumetric pressure vessel component 55 and spool housing 15 are threaded components and between them is washer 19 to make a tight seal. In alternative embodiments volumetric pressure vessel component 55 and spool housing 15 may be welded together.

Fluids flowing into volumetric pressure vessel valve 100 create a pressure differential across the spool which is measured by P_{delta}. When the pressure on the inlet side, Pᵢₙ, of the spool exceeds the sum of the pressure on the outlet side of the spool, Pₒᵤₜ, the valve will shut off. The pressure exerted by spring 30 on spool 20 is represented as Pₛₚₒₒₗ. If P_{delta} is greater than Pₛₚₒₒₗ, the valve remains in the open position. (Spool 20 is balanced and does not obstruct outflow aperture 14.) If P_{delta} is less than Pₛₚₒₒₗ, the valve will move to the closed position to respond to a line break, thus cutting off the flow of fluid through the hydraulic line.

In the embodiment shown, to illustrate the operation of volumetric pressure vessel valve 100, time duration of a surge is represented as T_{surge}. The duration of time necessary to compress and move spool 20 distance D is represented as Tₛₚₒₒₗ. If the duration of T_{surge} equals or exceeds the time Tₛₚₒₒₗ, the valve shuts and remains shut. Once the valve is shut, it will not reopen because there is no longer an opposing force from the system. In the embodiment shown, fluid accumulates in volumetric pressure vessel component 55 which delays the reaching of the threshold differential, and increases the duration of Tₛₚₒₒₗ.

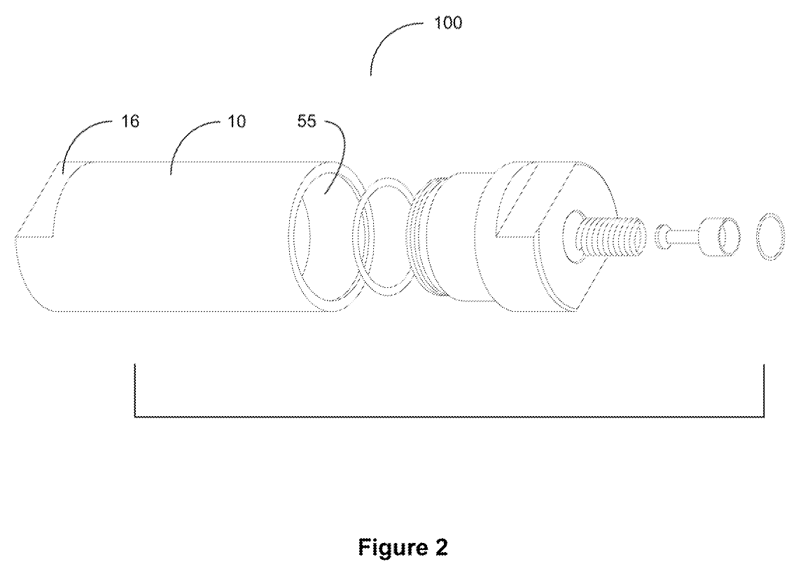

FIG. 2 illustrates an exploded view of one exemplary embodiment of volumetric pressure vessel valve 100 that includes integral components of valve housing 10, including volumetric pressure vessel component 55.

In the embodiment shown in FIG. 2, valve housing 10 further includes tool contour 16 for engaging tools and facilitating installation and maintenance. Valve housing 10 may be connected to a system or device by any means known in the art including by hex tubing, welding, sutures, fitted and interlocking components, threaded contours, forging, crimping, and machining.

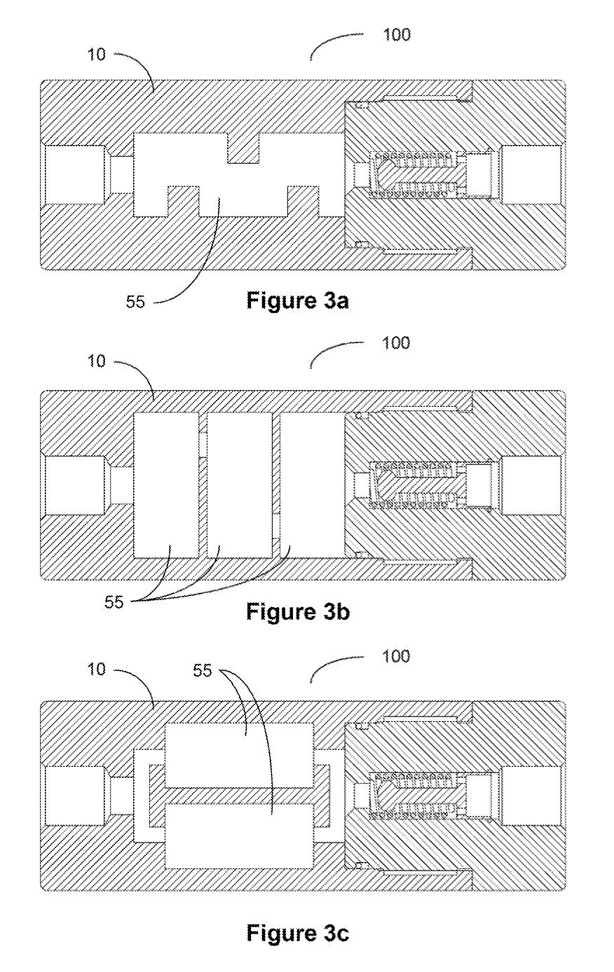

FIG. 3 shows alternate embodiments of volumetric pressure vessel valve 100 with different shapes and configurations of pressure vessel component 55. Valve housing 10 and volumetric pressure vessel component 55 can be of any shape or configuration known in the art (e.g., square, tubular, round, spiral, ribbed, multi-channeled, sieved, angular or any other shape or configuration). Volumetric pressure vessel component 55 can also be connected in series or in parallel.

FIG. 3a shows pressure vessel component 55 with buffers. Buffers can be of any size, shape, spacing, or of any number.

FIG. 3b shows three pressure vessel components 55 in series. Any number of pressure vessel components 55 can be in series together and may be of any size or shape.

FIG. 3c shows two pressure vessel components 55 connected in parallel. Any number of pressure vessel components 55 can be in parallel together and may be of any size or shape.

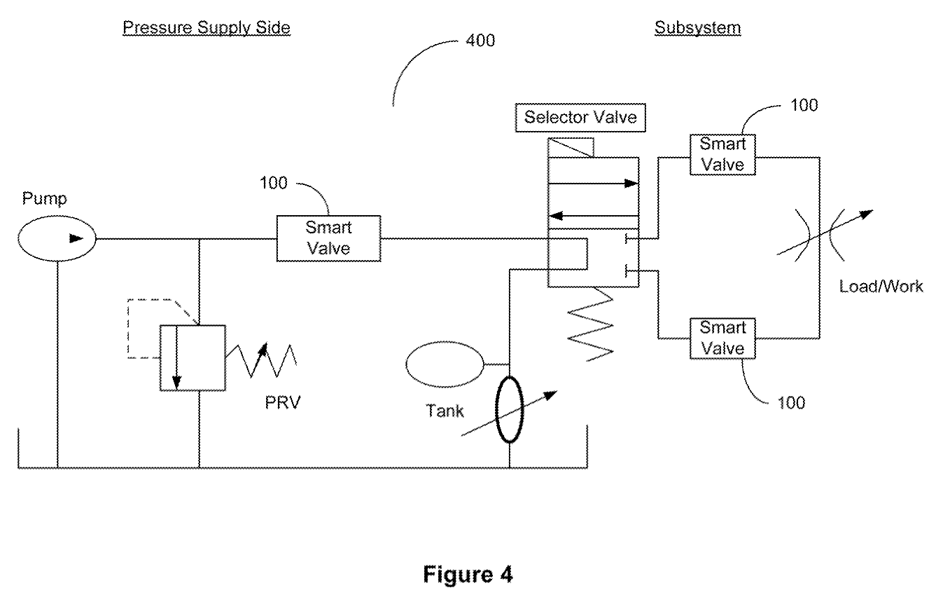

FIG. 4 shows an exemplary embodiment of hydraulic system 400 using volumetric pressure vessel valve 100 at various locations within hydraulic system 400 where a velocity fuse known in the art could not be located because of the propensity of the velocity fuse to cause hydraulic system failure during surges. For example, volumetric pressure vessel valve 100 is placed in the pressure supply side of hydraulic circuit for “main” system protection and in the alternating flow subsystem where work load is experienced to maximize protection of system. If volumetric pressure vessel valve 100 is placed in the pressure supply side of a hydraulic circuit, the smart valve acts as a main fuse pressure supply side protective shut-off valve. If volumetric pressure vessel valve 100 is placed in the lower volume subsystems, the volumetric pressure supply vessel's shape and size may change to maximize the protection and quick shut-off of fluid flow due to catastrophic line failures.

A difference between this system and those in the prior art is that this system allows you to place a valve at the main system (from pump to control valve which regulates the direction of the fluid flow) and subsystems (from the control valve to the cylinder). Velocity fuses known in the prior art are not capable of being placed on a system or subsystems and can go only on the cylinder where the work is being done. For example, for a lift truck known in the art, cylinders are required to have a velocity fuse because it atomically shuts off with a drop in pressure, i.e., the plunger goes inward and shuts off the flow. The system, however, still keeps pumping and causes spillage of whatever reservoir, e.g., reservoirs of a bulldozer, backhoe, crane, oil rig, or mining equipment. This also has medical implications and can be used with any system that deals with flow because all systems that deal with flow have some sort of reservoir.

What is claimed is:

1. A volumetric pressure vessel valve apparatus comprised of:
a valve housing;
at least one volumetric pressure vessel component;
a velocity fuse assembly;
an inflow aperture; and
an outflow aperture;
wherein the shape and size of said at least one volumetric pressure vessel compartment changes to maximize the shut-off of fluid flow.

2. The volumetric pressure vessel valve apparatus of claim 1 which includes multiple volumetric pressure vessel components.

3. The volumetric pressure vessel valve apparatus of claim 2 wherein said multiple volumetric pressure vessel components are connected in a series configuration.

4. The volumetric pressure vessel valve apparatus of claim 2 wherein said multiple volumetric pressure vessel components are connected in a parallel configuration.

5. The volumetric pressure vessel valve apparatus of claim 1 wherein the thickness of said valve housing is proportional to the volumetric pressure of the hydraulic system in which said volumetric pressure vessel valve is used.

6. The volumetric pressure vessel valve apparatus of claim 1 wherein the diameters of said inflow aperture and said outflow aperture are proportional to the Reynolds number representation.

7. The volumetric pressure vessel valve apparatus of claim 1 which further includes a spring.

8. The volumetric pressure vessel valve apparatus of claim 1 which further includes a snap ring.

9. The volumetric pressure vessel valve apparatus of claim 1 which further includes a spool.

10. The volumetric pressure vessel valve apparatus of claim 9 which further includes a spool housing threaded to said at least one volumetric pressure vessel component and a washer between said spool housing and said at least one volumetric pressure vessel component.

11. The volumetric pressure vessel valve apparatus of claim 1 wherein fluid accumulates in said at least one volumetric pressure vessel component.

12. The volumetric pressure vessel valve apparatus of claim 1 wherein said valve housing further includes a tool contour for engaging tools.

13. The volumetric pressure vessel valve apparatus of claim 1 wherein said at least one volumetric pressure vessel component is of a configuration selected from the group consisting of square, tubular, round, spiral, ribbed, multi-channeled, sieved, and angular.

14. A hydraulic system resistant to fluid surges comprised of:
multiple volumetric pressure vessel valves each comprised of:
a valve housing;
at least one volumetric pressure vessel component;
a velocity fuse assembly;
an inflow aperture; and
an outflow aperture.

15. The hydraulic system of claim 14 wherein said multiple volumetric pressure vessel valves are connected in series.

16. The hydraulic system of claim 14 wherein said multiple volumetric pressure vessel valves are connected in parallel.

17. The hydraulic system of claim 14 wherein at least one of said multiple volumetric pressure vessel valves is located in the pressure supply side of said hydraulic system.

18. The hydraulic system of claim 14 wherein at least one of said multiple volumetric pressure vessel valves is located in the lower volume subsystem of said hydraulic system.

19. The hydraulic system of claim 14 wherein said hydraulic system further includes equipment having at least one reservoir, said equipment selected from the group consisting of a bulldozer, backhoe, crane, oil rig and mining equipment.
